(19) United States
(12) Patent Application Publication
(10) Pub. No.: US 2011/0269105 A1
(43) Pub. Date: Nov. 3, 2011

(54) Abutment for an implant system

(75) Inventor: Dirk Jahn, Neustadt (DE)

(73) Assignee: nt-trading GmbH & Co. KG

(21) Appl. No.: 12/925,180

(22) Filed: Oct. 15, 2010

(30) Foreign Application Priority Data
Apr. 29, 2010 (DE) 10 2010 019 387.9

(51) Int. Cl. A61C 8/00

(52) U.S. Cl. 433/174; 433/175

(57) ABSTRACT

An abutment for an implant system including a root section that can be anchored in an implant and a head section for the accommodation of a prosthetic item, characterized in that a peripheral surface of the head section is rotationally symmetrical in relation to a longitudinal center axis (L) of said abutment and is tapered toward an end face of the head section which is remote from said root section.

### FIELD OF THE INVENTION

The present invention relates to an abutment for an implant system, and more specifically, an abutment including a root section that can be anchored in an implant and a head section adapted for the accommodation of a prosthetic item.

### BACKGROUND OF THE INVENTION

An abutment of this kind is disclosed in DE 11 2005 003 621 T5. The abutment disclosed comprises an axially asymmetrical head section for the accommodation of a dental prosthetic item and a root section for fixing the abutment to an implant anchored in human bone. The abutment is made of titanium.

Abutments for dental prosthetic items are provided with a protruding head section which is in alignment with, or at an angle to, the root section, depending on the individual type of anchorage of the implant in the jawbone. As a result, in prior implant systems, it is necessary to have a reserve of a plurality of variously angled abutments.

### SUMMARY OF THE INVENTION

It is an object of the invention to provide an abutment of the aforementioned kind that is universally applicable to various orientations of the implant.

This object is achieved in that a peripheral surface of the head section is configured so as to be rotationally symmetrical relative to a longitudinal center axis of the abutment and to be tapered toward its end face remote from the root section. The rotationally symmetrical shape of the head section together with the taper toward its end face makes it possible to employ the abutment of the invention universally as a standardized component for both prosthetic items aligned with a longitudinal axis of the implant as well as prosthetic items that are at an angle to the longitudinal axis of the implant. The solution of the invention is suitable, to particular advantage, for dental implant systems and corresponding dental prosthetic items. In principle, the solution provided by the invention is also suitable for other human implant systems comprising corresponding types of human prosthetic items such as, inter alia, finger or toe bones. The tapered shape of the peripheral surface of the head portion toward its end face can be linear, convex, constricted, or stepped.

In one embodiment of the invention, the head section is configured so as to be conically tapered. A corresponding frustoconical shape is easy to produce on an economical basis.

In a further embodiment of the invention, provision is made for the peripheral surface of the head section to be inclined in relation to the longitudinal center axis over an angular range of from 0° to 25° . Particularly preferred are angular ranges of from 12° to 15°, which is equivalent to abutments having angulations of from 12° to 15°.

In a further embodiment of the invention, a separate, bell-shaped adapter element is assigned to the head section and the inside wall surface of the adapter element is configured in a complementary manner to the peripheral surface of the head section so as to be rotationally symmetrical and tapered. The abutment and the adapter element form a multi-component abutment system, the adapter element being joined, more particularly by bonding, to the dental prosthetic item, and this unit consisting of the dental prosthetic item and the adapter element is then joined to the abutment. The adapter element encompasses the head section coaxially and with accuracy of fit so that the former can be rotated before being fixed to the head section. The adapter element is thus fitted to the head section such that it is free to rotate thereon. The abutment itself is inserted into a corresponding implant such that it is free to rotate therein.

In a further embodiment of the invention, the bell-shaped adapter element comprises a through opening that is concentric to a longitudinal center axis and is delimited by an annular shoulder serving as a supporting surface for a securing element. The opening is intended for the accommodation of a securing element, more particularly a headed screw, protruding through the adapter element.

In a further embodiment of the invention, an external peripheral surface of the adapter element is rotationally symmetrical relative to the longitudinal center axis and tapered toward an end face. This external peripheral surface is one that is very easy to produce and that makes it possible to insert the adapter element easily and with accuracy of fit into a complementary dental prosthetic item. The dental prosthetic item preferably has a corresponding recess that is rotationally symmetrical and tapered toward the base of the recess. The dental prosthetic item is preferably mounted on the external peripheral surface of the adapter element by means of bonding. The dental prosthetic item comprises a through-hole that is coaxially aligned with the hole in the adapter element in order to allow securing means such as, in particular, a screw, to pass therethrough.

In a further embodiment of the invention, the head section comprises a blind bore that is open in the end face of the head section and is provided with anchoring means such as, in particular, an female thread for securing a prosthetic item or the adapter element. The anchoring means are preferably adapted to match the securing element cooperating with the adapter element. In a particularly advantageous manner, the securing element is in the form of a headed screw, and the anchoring means is in the form of a female thread in the blind bore configured complementarily to a male thread on the headed screw.

In a further embodiment of the invention, the walls of the blind bore are provided with tool-engaging surfaces for the non-rotational accommodation of a turning tool. It is thus possible to screw the abutment into the implant by means of a suitable turning tool, such as an Allen wrench or the like.

In a further embodiment of the invention, the abutment and/or the adapter element are made of metal, more particularly titanium, and/or ceramics, more particularly zirconium oxide. These materials are particularly suitable for human implant systems and more particularly for dental implant systems

In a further embodiment of the invention, the head section and the adapter element can be joined together by bonding, welding or similar processes, or by force-fit or non-positive interconnection. Advantageously, these elements are joined by means of adhesion or non-positively by means of a screw connection or a press fit. Due to the axially symmetrical shape of the components of the invention, the elements can be oriented in various rotational positions relatively to each other depending on requirements, and then secured in the desired position by bonding, by a screw connection, or by any other form of non-positive fitting or adhesive or cohesive jointing.

### BRIEF DESCRIPTION OF THE DRAWINGS

Additional advantages and features of the invention are revealed by the claims and the following explanation of preferred exemplary embodiments of the invention described with reference to the drawings.

FIG. 1 shows perspective arrangements of abutments of the invention in dental implant systems;

FIG. 2 is an enlarged view of an abutment shown in FIG. 1;

FIG. 3 shows a longitudinal section of the abutment shown in FIG. 2;

FIG. 4 is an enlarged view of a detail IV of the abutment shown in Fig.

FIG. 5 is a top view of the abutment shown in FIGS. 2 and 3;

FIG. 6 is a perspective view of the abutment shown in FIG. 2;

FIG. 7 is an exploded perspective view of a multi-piece abutment, in which an adapter element is inserted in a dental crown;

FIG. 8 is a top view of the adapter element of the two-piece abutment shown in

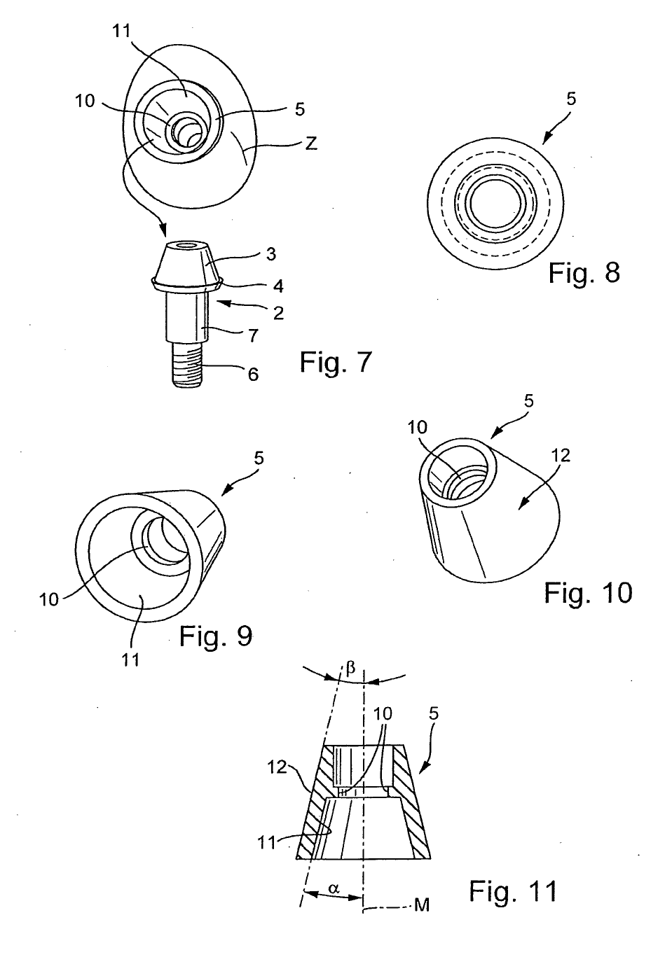

FIG. 7;

FIG. 9 is a perspective view taken obliquely from below of the adapter element shown in FIG. 8;

FIG. 10 is a perspective view taken obliquely from above of the adapter element shown in FIG. 8; and

FIG. 11 is a longitudinal section of the adapter element shown in FIG. 8.

To facilitate understanding of the invention, identical reference numerals have been used, when appropriate, to designate the same or similar elements that are common to the figures.

### DETAILED DESCRIPTION OF THE INVENTION

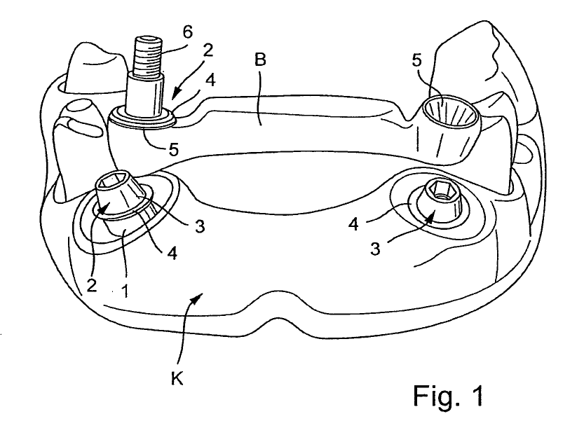

A dental implant system comprises one or more implants 1 that are inserted in a bone bed inside a jawbone K in a manner known per se such that they “grow” into the bone. The implants 1 are oriented in the jawbone K according to the individual bone structure. In order to make it possible to fix a dental prosthetic item such as a bridge B (FIG. 1) or a dental crown Z (FIG. 7) to the corresponding implant 1, one-piece or two-piece abutments 2, 5 are provided that are described in more detail below with reference to FIGS. 1 to 11.

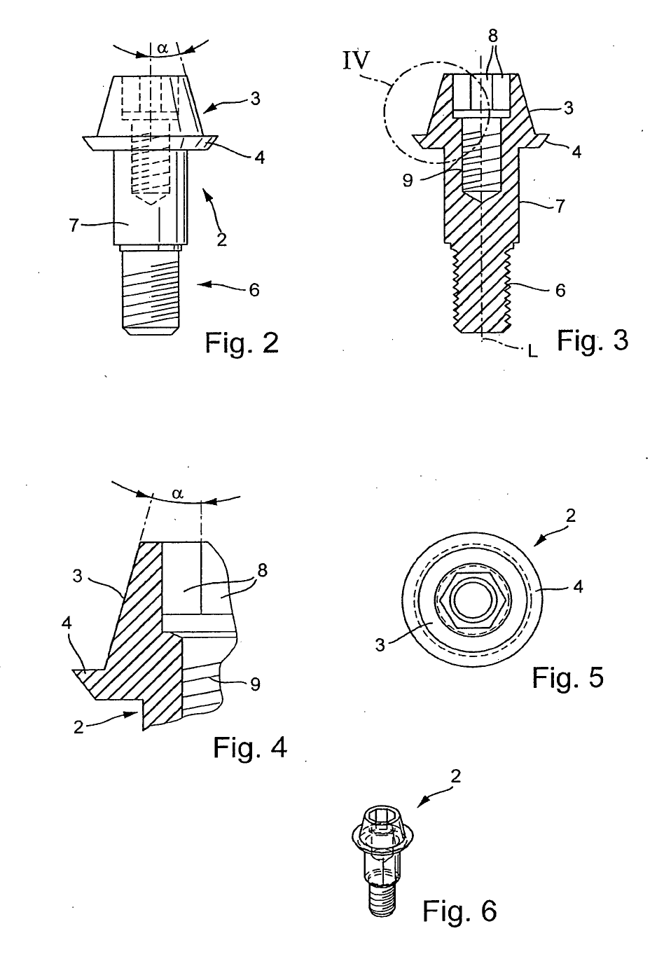

An abutment 2 shown in FIGS. 2 to 7 is made of titanium and is configured so as to be substantially axially (rotationally) symmetrical relative to a longitudinal center axis L (FIG. 3). The abutment 2 has a root section 6, 7 provided with a male thread and consisting of a central cylindrical portion and a lower, threaded portion. The threaded portion has a male thread that can be screwed into a corresponding female thread in the implant 1 in a manner not shown in detail. A head section 3 having a frustoconical peripheral surface and an annular shoulder 4, which delimits the peripheral surface in the downward direction, adjoins the top of the root section 6, 7. The conically tapered peripheral surface has is at an angle of inclination a relative to the longitudinal center axis L, which angle is equal to 14.6° in the exemplary embodiment shown.

The male thread of the threaded portion 6 is an M2 thread. The abutment 2 shown in FIG. 2 has an overall height of about 10 mm.

Starting from a top end face of the head section 3, the abutment 2 is provided with a blind bore having a female thread 9 and tool-engaging surfaces, above the female thread 9, for a turning tool in the form of an octagonal wrench, more particularly an Allen wrench. The diameter of the threaded bore 9 is smaller than that of the octagonal recess forming the tool-engaging surfaces 8. It is possible by means of these tool-engaging surfaces 8 to screw the abutment 2 into the implant 1 with the help of a suitable tool. The head section 3 and the root section 6, 7 are composed of an appropriately machined single-piece solid body.

The peripheral surface of the head section 3 of the abutment 2 serves to accommodate a dental prosthetic item such as a crown Z or a bridge B, in particular. The corresponding dental prosthetic item is machined in the region of its bottom surface so as to be complementary to the conical head section 3 in that a recess that conically tapers in a corresponding manner toward its base is provided in the bottom surface of the dental prosthetic item. Furthermore, a bore is provided in the dental prosthetic item in the top surface thereof, which bore is coaxial to the conical recess and extends downwardly through the dental prosthetic item from the top. The dental prosthetic item is fitted onto the head section 3 by way of its conical recess without play and with accuracy of fit, as a result of which its edge rests on the annular shoulder 4 of the abutment 2. A suitable way of fixing the dental prosthetic item to the head section can be effected using a headed screw that is inserted downwardly through the dental prosthetic item and then secured in the threaded bore 9 of the blind bore of the abutment 2. As a result, the dental prosthetic item is pressed against the conical peripheral surface 3 of the head section and against the annular shoulder 4 of the abutment 2 serving as an annular stop. Additionally or alternatively, it is possible to bond an appropriately machined dental prosthetic item to the head section 3 of the abutment 2.

According to the further embodiment shown in FIGS. 1 and 7, the abutment is in the form of a two-piece system in that a bell-shaped adapter element 5 is additionally assigned to the abutment 2 (FIGS. 7 to 11). The adapter element 5 is substantially frustoconical in shape and comprises—when viewed from the top in its mounted position—a cylindrical accommodating bore that merges into a through bore of smaller diameter forming an annular shoulder 10. An inside wall surface 11 of the adapter element 5 widens downwardly in a frustoconical and thus conical manner. The inside wall surface 11 of the adapter element 5 is inclined relatively to a longitudinal center axis M of the adapter element 5 at the same angle α at which the peripheral surface of the head section 3 of the abutment 2 is inclined relatively to the longitudinal center axis L. The depth of the inside wall surface 11—when measured along the longitudinal center axis M—is almost identical to the height of the peripheral surface of the head section 3. The upper and lower rim diameters of the frustoconical sections are also substantially identical to each other so that the adapter element 5 can be fitted completely, without play and with accuracy of fit, to the head section 3.

An upper marginal surface of the annular shoulder 4 of the head section 3 rises slightly outwardly by a gradient ranging from 1° to 2°, in this case at an angle of exactly 1.11°, relative to a normal to the longitudinal center axis L. This makes it possible to position a lower front edge of the adapter element 5 securely to the annular shoulder 4, in the mounted state.

An external peripheral surface of the adapter element 5 is oriented so as to be slightly steeper in relation to the inside wall surface 11. In the present exemplary embodiment an angle β of 13°, corresponding to the angle α of 14.6°, is formed by the external peripheral surface 12 in relation to the longitudinal center axis M. The adapter element 5 is also made of titanium in the exemplary embodiment shown. According to some embodiments of the invention (not shown), the adapter element, like the abutment 2, can alternatively be made of suitable high-grade ceramics instead of metal.

According to FIG. 1 or 7, the adapter element 5 is adapted to be inserted in a corresponding recess in a dental prosthetic item such as a bridge B, a dental crown Z, or the like and to be firmly bonded to the surface of a corresponding recess in the dental prosthetic item. For this purpose, the adapter element 5 is preferably first inserted into the dental prosthetic item until flush therewith and then the unit consisting of the dental prosthetic item and the adapter element 5 is fitted onto the head section 3 of the relevant abutment 2. The adapter element 5 with the dental prosthetic item is then firmly joined to the abutment 2 by means of an appropriate headed screw, which is inserted from the top down through the dental prosthetic item into the adapter element 5 so as to rest against the supporting shoulder 10, whereupon the headed screw is screwed into the threaded bore 9 in the abutment 2. In the illustration presented in FIG. 1, the dental prosthetic item depicted is a bridge B, which has two junction points for attachment to appropriate implants 1. Purely by way of example, the bridge B is shown to comprise an inserted adapter element 5 on the right-hand side and an inserted abutment 2 on the left-hand side. To make it possible to fit the bridge B onto the abutments 2 inserted in the implants in the jawbone K, the left-hand abutment 2 protruding upwardly with its root section 6 would have to be removed from the bridge item B. The illustration presented in FIG. 1 is thus intended purely to show the different variants of the invention without the bridge B in the embodiments shown being in fact capable of being fitted to the two abutments 2 inserted in the jawbone K.

As indicated by the arrow in FIG. 7, the dental crown Z with an already inserted adapter element 5 is fitted to the head section 3 of the abutment 2 and screwed to the abutment 2.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

I claim:

1. An abutment for an implant system, comprising a root section that can be anchored in an implant and a head section for the accommodation of a prosthetic item, characterized in that a peripheral surface of the head section (3) is rotationally symmetrical in relation to a longitudinal center axis (L) of said abutment (2) and is tapered toward an end face of the head section which is remote from said root section (6, 7).

2. The abutment as defined in claim 1, characterized in that said head section (3) is conically tapered.

3. The abutment as defined in claim 2, characterized in that said peripheral surface of said head section (3) is inclined relatively to the longitudinal center axis (L) in an angular range of 0 degrees to 25 degrees.

4. The abutment as defined in claim 1, characterized in that to said head section (3) there is assigned a separate, bell-shaped adapter element (5), whose inside surface (11) is complementary to said peripheral surface of said head section (3) and is rotationally symmetrical to a longitudinal center axis (M) and tapered.

5. The abutment as defined in claim 4, characterized in that said bell-shaped adapter element (5) has a through hole which is concentric with a longitudinal center axis (M) and which is delimited by an annular shoulder (10) serving as a contact surface for a securing element.

6. The abutment as defined in claim 4, characterized in that a peripheral surface (12) of said adapter element (5) is rotationally symmetrical to said longitudinal center axis (M) and is tapered toward an end face.

7. The abutment as defined in claim 4, characterized in that said head section (3) has a blind bore which is open in the end face of said head section (3) and is provided with means for securing a prosthetic item (B, Z) or said adapter element (5).

8. The abutment as defined in claim 7, characterized in that the inside surface of the blind bore is provided with tool-engaging surfaces (8) for the non-rotational accommodation of a turning tool.

9. The abutment as defined in claim 1, characterized in that said abutment (2) is fabricated from at least one of titanium, ceramics, and zirconium oxide.

10. The abutment as defined in claim 7, characterized in that said head section (3) and/or said adapter element (5) and/or a prosthetic item (B, Z) can be adhesively or cohesive or non-positively interconnected.

11. The abutment of claim 7, wherein the securing means is a female thread (9) for securing said prosthetic item (B, Z) or said adapter element (5).

12. The abutment as defined in claim 4, characterized in that said adapter element (5) is fabricated from at least one of titanium, ceramics, and zirconium oxide.
